(19) United States
(12) Patent Application Publication
(10) Pub. No.: US 2007/0216255 A1
(43) Pub. Date: Sep. 20, 2007

(54) ELECTRIC MACHINE

(76) Inventors: Thomas Weigold, Baden-Baden (DE); Gerald Roos, Sasbachried (DE); Michael Albrecht, Buehl (DE); Andreas Saum, Buehl (DE); Juergen Herbst, Rastatt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/680,788

(22) Filed: Mar. 1, 2007

(30) Foreign Application Priority Data
Mar. 14, 2006 (DE) 10 2006 011 550.3

(51) Int. Cl. H02K 23/26; H01R 39/32; H01R 39/40

(52) U.S. Cl. 310/234; 310/198; 310/246

(57) ABSTRACT

An electric machine including armature equipped with armature slots for accommodating armature coils, a commutator equipped with commutator segments, and a first and second hammer brush that each rest against the commutator in sliding fashion by means of a spring lever, in which at least one armature coil is comprised of two partial coils that are situated symmetrically to each other in relation to the rotation axis of the armature and the partial coils are connected to two adjacent commutator segments of the commutator.

### REFERENCE TO FOREIGN PATENT APPLICATION

This application is based on German Patent Application No. 10 2006 011 550.3 filed 14 Mar. 2006, upon which priority is claimed.

### BACKGROUND OF THE INVENTION

1. Field of the Invention

The invention relates to an electric machine, in particular a DC machine.

2. Description of the Prior Art

It is know from the prior art, e.g. WO 00/036729 A, to embody the commutator brushes of an electric machine in the form of hammer brushes. Hammer brushes are equipped with spring levers that are prestressed toward the commutator. In this case, one lever end is affixed, for example, to a support piece of the brush holder while the other lever end supports the carbon brush resting against the commutator.

With the use of hammer brushes, the problem arises that brush wear over the service life causes the contact points of the brushes on the commutator to shift in relation to one another. This changes the commutation times of the two brushes so that they can no longer commutate simultaneously. This can generate radial forces that lead to an increased motor noise.

### SUMMARY OF THE INVENTION

The electric machine according to the invention has the advantage that the symmetrical winding compensates for the radial forces that are caused by the shifting of the contact points of the brushes on the commutator due to brush wear. This compensation is achieved by virtue of the fact that the short-circuit current in the two partial coils of the symmetrical winding occurs simultaneously and with the same intensity so that the radial forces of the respective partial coils compensate for each other, thereby exerting no resulting radial force on the armature. This significantly improves the quiet running of the motor.

According to the invention, at least one armature coil is comprised of two partial coils situated symmetrically to each other in relation to the rotation axis of the armature; the partial coils are connected to two adjacent commutator segments of a commutator. This means that the armature coils are embodied so that the members of each pair of partial coils are situated symmetrically to each other in relation to the rotation axis of the armature. The two partial coils situated symmetrically to each other are connected to two adjacent commutator segments of a commutator.

According to the invention, the two partial coils are situated symmetrically to each other in such a way that when the partial coils are supplied with power in a magnetic field, essentially no radial forces act on the armature. The two partial coils can be commutated simultaneously, for example by being connected to adjacent commutator segments. The resulting radial forces are compensated for particularly well because the two partial coils are situated essentially geometrically parallel to each other and spaced the same distance apart from the rotation axis of the armature. In addition, the radial forces can be compensated for particularly well because the two partial coils have the same number of windings The radial forces can also be compensated for particularly well because the two partial coils are wound in the opposite winding directions from each other. In particular, this is a two-pole electric winding.

The two partial coils can be electrically connected to each other either in series or in parallel. When connected in series, the two partial coils have two ends that are connected to adjacent commutator segments. But when connected in parallel, each of the two partial coils has two ends and the ends of one partial coil are connected to adjacent commutator segments.

In a preferred embodiment, the commutator has an even number of segments. It is also preferable for the number of segments to equal the number of armature slots.

The electric machine according to the invention has at least two hammer brushes that rest against the commutator in sliding fashion by means of spring levers. The two hammer brushes in this case are situated opposite each other. In order to assure the most uniform possible current flow during commutation, the brush width is selected so that as the commutator rotates, the brushes each overlap two adjacent segments in order to short-circuit them. This significantly reduces brush discharge.

In another embodiment of the electric machine, a third hammer brush can be provided for speed adjustment and is situated radially between the opposing hammer brushes (referred to below as the first and second hammer brush). In this embodiment, the third hammer brush is offset in relation to the first hammer brush in the rotation direction by a certain angle less than 180°, e.g. 70°. In this case, in the low speed stage, the two opposing hammer brushes, i.e. the first and second hammer brushes, are supplied with power while the third hammer brush is without power. In the high speed stage, the second and third hammer brushes are supplied with power, whereas the first hammer brush is without power. The second hammer brush thus constitutes the shared brush that cooperates with the first hammer brush at low speeds and cooperates with the third hammer brush at high speeds. The respective hammer brush that is without power connects two respective adjacent commutator segments. In a conventional winding, it thus short circuits the intervening coil, thereby giving rise to a short-circuit current that is oriented counter to the direction of the supply current and results in a radial force on the armature. In the electric machine according to the invention, this radial force is avoided because instead of a coil, two symmetrically situated partial coils contact adjacent commutator segments. If two adjacent commutator segments are connected by the respective hammer brush without power, then a short-circuit current arises in the two partial coils so that the radial forces of the two partial coils compensate for each other.

In another preferred embodiment, the symmetrically arranged partial coils are embodied in two layers as a double winding with a reduced coil wire cross section, i.e. half of this cross section. This makes it possible to achieve an increased slot space factor.

For example, the electric machine according to the invention can be a two-pole DC motor for driving moving parts in a motor vehicle, e.g. a windshield wiper motor, power window unit, or power seat adjusting motor.

### BRIEF DESCRIPTION OF THE DRAWINGS

The invention will be explained in detail below, in conjunction with the accompanying drawings, in which:

FIG. 1a shows an electric machine with two hammer brushes when new,

FIG. 1b shows an electric machine with two hammer brushes at the end of their service life,

FIG. 2 shows a first embodiment of armature coils with two symmetrical partial coils connected in series,

FIG. 3 shows a second embodiment of armature coils with two symmetrical partial coils connected in parallel, and

FIG. 4 shows an arrangement of three hammer brushes that are positioned against a commutator, offset from each other in the rotation direction.

### DESCRIPTION OF THE PREFERRED EMBODIMENTS

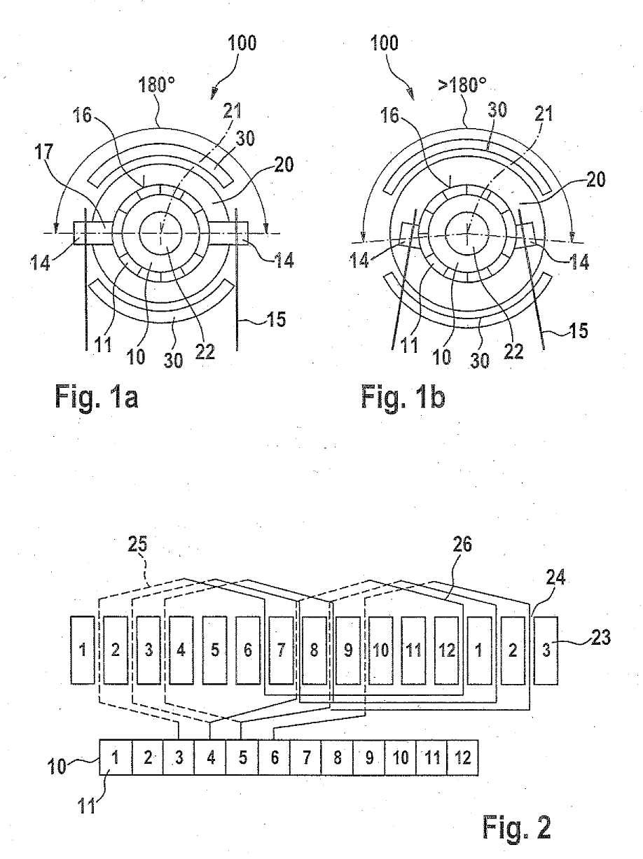

The schematic depiction in FIG. 1 shows how wear on the hammer brushes over the service life causes the contact points of the brushes on the commutator to shift in relation to one another. FIG. 1a shows an electric machine 100, which has an armature 20, two magnetic poles 30, and a commutator 10 with commutator segments 11. The armature 20 and the commutator 10 are torsionally secured to an armature shaft 22 with a rotation axis 21. A first and second hammer brush 14 rest against the commutator 10 in sliding fashion by means of spring levers 15. The two hammer brushes 14 are situated opposite each other so that when the brushes 14 are new, the brush middles 17 rest against the commutator surface 16, offset from each other by an angle of 180°. FIG. 1b shows the arrangement comprised of the commutator 10 and two opposing hammer brushes 14 at the end of the service life of the brushes 14. Due to brush wear, the brush middles 17 contact the commutator surface 16 over an angle of more than 180°. As a result, the commutation time of the two hammer brushes 14 changes so that the two brushes 14 no longer commutate simultaneously and undesirable radial forces act on the armature.

FIG. 2 schematically depicts a partial development of a first embodiment of armature coils, each of which has two symmetrical partial coils. In the embodiment shown, the commutator 10 has twelve segments 11 and the armature 20 has twelve teeth 23 and twelve armature slots 24. The armature coil is wound like a lap winding in the form of a fractional pitch winding. The winding of a first partial coil 25 lies in the first armature slot 24 between the first and second tooth 23 and in the sixth armature slot 24 between the sixth and seventh tooth 23. The winding of a second partial coil 25 lies in the twelfth armature slot 24 between the twelfth and first tooth 23 and in the seventh armature slot 24 between the seventh and eighth tooth 23. The two ends of the first and second partial coil 25, 26 are electrically connected to adjacent commutator segments 11 (in this case, the third and fourth ones). The two partial coils 25, 26 are thus connected in series. The first and sixth armature slot 24 and the seventh and twelfth armature slot 24, respectively, are situated opposite each other so that the two partial coils 25, 26 are symmetrical to each other in relation to the rotation axis 13 of the armature 20 and extend parallel to each other; the two partial coils 25, 26 are wound in the opposite winding direction from each other. In the exemplary embodiment shown, the first partial coil 25 is wound first, before the second partial coil 26 is wound. Alternatively, however, it is also possible to wind the two partial coils 25, 26 in alternating fashion.

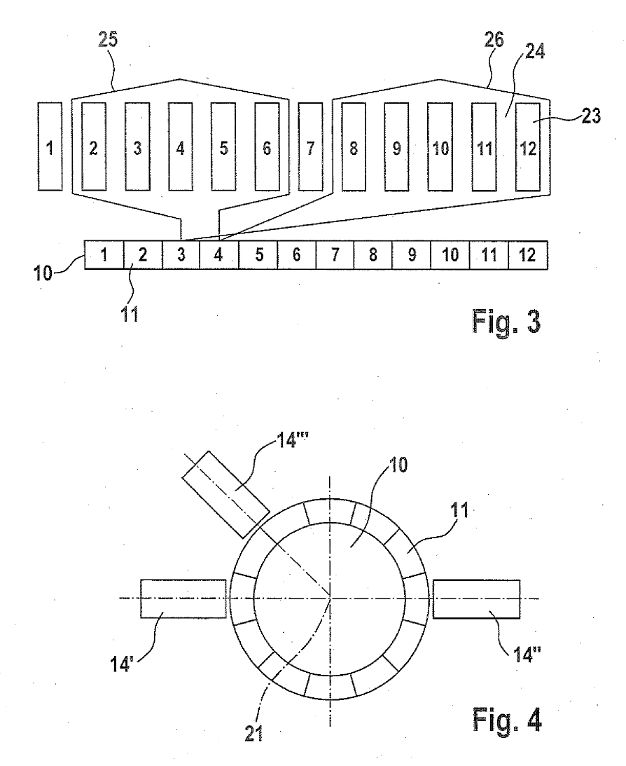

FIG. 3 schematically depicts a partial development of a second embodiment of armature coils, each with two symmetrical partial coils. In the embodiment shown the commutator 10 once again has twelve segments 11 and the armature 20 has twelve teeth 23 and twelve armature slots 24. The armature coil is once again wound like a lap winding in the form of a fractional pitch winding. The winding of a first partial coil 25 lies in the first armature groove 24 between the first and second tooth 23 and in the sixth armature groove 24 between the sixth and seventh tooth 23. The winding of a second partial coil 26 lies in the twelfth armature slot 24 between the twelfth and first tooth 23 and in the seventh armature slot 24 between the seventh and eighth tooth 23. The two partial coils 25, 26 are connected in parallel in that the two ends of each partial coil 25, 26 are electrically connected to adjacent commutator segments 11.

FIGS. 2 and 3, respectively, show an embodiment of a series connection and a parallel connection of the two partial coils 25, 26. Many other winding schemes can be implemented in accordance with the depicted principal of the winding of two symmetrically situated partial coils 25, 26.

FIG. 4 schematically depicts the arrangement of three hammer brushes 14′, 14″, 14′″. The hammer brushes 14′, 14″, 14′″ here are depicted in simplified fashion in the form of blocks. A first hammer brush 14′ and a second hammer brush 14″ are situated opposite each other. A third hammer brush 14′″ is situated radially between the first and second hammer brushes 14′, 14″, i.e. the third hammer brush 14′″ is offset in relation to the first hammer brush 14′ in the rotation direction by a certain angle, in this case by 45°, for example. In the low speed stage, the two opposing hammer brushes here, i.e. the first and second hammer brushes 14′, 14″, are supplied with power whereas in the high speed stage, the second and third hammer brushes 14″, 14′″ are supplied with power. The second hammer brush 14″ thus constitutes the shared brush that cooperates with the first hammer brush 14′, at low speeds and cooperates with the third hammer brush 14′″ at high speeds.

The foregoing relates to preferred exemplary embodiments of the invention, it being understood that other variants and embodiments thereof are possible within the spirit and scope of the invention, the latter being defined by the appended claims.

1. In an electric machine including an armature equipped with armature slots for accommodating armature coils, a commutator equipped with commutator segments, and a first and second hammer brush that each rest against the commutator in sliding fashion by means of a spring lever, the improvement wherein at least one armature coil is comprised of two partial coils that are situated symmetrically to each other in relation to the rotation axis of the armature and the partial coils are connected to two adjacent commutator segments of the commutator.

2. The electric machine according to claim 1, wherein the two partial coils are situated essentially geometrically parallel to each other.

3. The electric machine according to claim 1, wherein the two partial coils have the same number of windings.

4. The electric machine according to claim 2, wherein the two partial coils have the same number of windings.

5. The electric machine according to claim 1, wherein the two partial coils are wound in opposite winding directions.

6. The electric machine according to claim 2, wherein the two partial coils are wound in opposite winding directions.

7. The electric machine according to claim 3, wherein the two partial coils are wound in opposite winding directions.

8. The electric machine according to claim 1, wherein the two partial coils are electrically connected in series.

9. The electric machine according to claim 2, wherein the two partial coils are electrically connected in series.

10. The electric machine according to claim 3, wherein the two partial coils are electrically connected in series.

11. The electric machine according to claim 5, wherein the two partial coils are electrically connected in series.

12. The electric machine according to claim 8, wherein the two series-connected partial coils have two ends that are connected to adjacent commutator segments.

13. The electric machine according to claim 9, wherein the two series-connected partial coils have two ends that are connected to adjacent commutator segments.

14. The electric machine according to claim 10, wherein the two series-connected partial coils have two ends that are connected to adjacent commutator segments.

15. The electric machine according to claim 11, wherein the two series-connected partial coils have two ends that are connected to adjacent commutator segments.

16. The electric machine according to claim 1, wherein the two partial coils are electrically connected in parallel.

17. The electric machine according to claim 16, wherein each of the two parallel-connected partial coils has two ends and the ends of each respective partial coil are connected to adjacent commutator segments.

18. The electric machine according to claim 1, further comprising a third hammer brush, the first and second hammer brushes being situated opposite each other and cooperating in a first speed stage and the third hammer brush being situated radially between the first and second hammer brush and cooperating with the second hammer brush in a second speed stage.

19. The electric machine according to claim 2, further comprising a third hammer brush, the first and second hammer brushes being situated opposite each other and cooperating in a first speed stage and the third hammer brush being situated radially between the first and second hammer brush and cooperating with the second hammer brush in a second speed stage.

20. The electric machine according to claim 3, further comprising a third hammer brush, the first and second hammer brushes being situated opposite each other and cooperating in a first speed stage and the third hammer brush being situated radially between the first and second hammer brush and cooperating with the second hammer brush in a second speed stage.
